(19) United States
(12) Patent Application Publication
(10) Pub. No.: US 2013/0252577 A1
(43) Pub. Date: Sep. 26, 2013

(54) CHARGING STATION FOR MOBILE ELECTRONIC DEVICES AND AN ASSOCIATED SYSTEM AND METHOD

(71) Applicant: ECONET WIRELESS IP HOLDINGS LIMITED, Ebene (MU)

(72) Inventor: Colin Stephen JORDAN, Randburg (ZA)

(73) Assignee: ECONET WIRELESS IP HOLDINGS LIMITED, Ebene (MU)

(21) Appl. No.: 13/712,215

(22) Filed: Dec. 12, 2012

(30) Foreign Application Priority Data
Mar. 23, 2012 (ZA) 1012/02156

(51) Int. Cl. H04W 4/26

(52) U.S. Cl. CPC H04W 4/26
USPC 455/406

(57) ABSTRACT

The invention relates to a charging station (100) for charging mobile electronic devices (404), and an associated server (300), system (400), and method (500). The charging station (100) includes a plurality of lockable enclosures (120), each having an associated charging terminal (222), an input arrangement (124) operable to receive a mobile subscriber identifier, and a communication module (122) operable to communicate with a remote authorisation server (300). The charging station (100) further includes a control module (206) operable to generate and send, via the communication module (122), a query communication including the mobile subscriber identifier to the remote authorisation server (300), the query communication serving to query whether or not the subscriber (406) has sufficient airtime in his account to pay for use of the charging station (100), to receive, via the communication module (122), a response communication, and to provide access to a lockable enclosure (120) and its associated charging terminal (222), in response to the subscriber (406) having sufficient airtime.

### FIELD OF INVENTION

The invention relates broadly to charging of batteries and more specifically to a charging station for the selective charging of mobile electronic devices, such as mobile telephones.

### BACKGROUND OF INVENTION

The Applicant has noted the omnipresence of mobile electronic devices, such as mobile telephones, which required charging intermittently. For a number of reasons, the users of such mobile electronic devices may wish to charge them at a publicly available facility, for example if they do not have access to charging facilities at home or at work, if they forgot, or if the battery of their device has unexpectedly run flat due to heavier-than-normal use.

The Applicant is aware of an existing charging station which has a series of lockable enclosures, each having an associated charging terminal. A user can place their device into the enclosure and connect it to the charging terminal. The user can then lock the enclosure with a key (locker-fashion) and leave the device to be charged. The user can return and retrieve their device some time later. The Applicant is aware of both free and paid versions of the apparatus. The free version may be operated as a service or as part of a promotion. The paid version is coin operated.

The Applicant has noted drawbacks with these prior art apparatus. The free version is expensive to operate and does not recoup its costs. It would not be suitable for mass deployment (like, for example, ATM terminals) because it would run at a loss, both capital and income. The paid version is inconvenient as money needs to be carried. Further, the apparatus is then susceptible to robbery and no effective audit mechanism is available. Also, keys or locks for the enclosures might not be returned or maintained in good working order.

The Applicant desires an apparatus in the form of a charging station, and an associated system and method, which overcomes or at least alleviates these drawbacks.

### SUMMARY OF INVENTION

According to one aspect of the system, there is provided a charging station for charging mobile electronic devices, the charging station including:
a plurality of lockable enclosures, each having an associated charging terminal;
an input arrangement operable to receive a mobile subscriber identifier;
a communication module operable to communicate with a remote authorisation server;
a control module operable to:
   generate and send, via the communication module, a query communication including the mobile subscriber identifier to the remote authorisation server, the query communication serving to query whether or not the subscriber has sufficient airtime in his account to pay for use of the charging station;
   receive, via the communication module, a response communication indicative of whether or not the subscriber has sufficient airtime in his account to pay for use of the charging station; and
   provide access to a lockable enclosure and its associated charging terminal, in response to the subscriber having sufficient airtime.

In the context of this specification, charging refers to battery charging.

Each enclosure may be electronically lockable. The charging station may therefore include a plurality of electronic locks respectively associated with the enclosures. In such case, the control module may provide access to a lockable enclosure by issuing a code to the subscriber. The code may be a temporary code. The code may be in the form of a PIN or other suitable credential. Each lock may have a keypad associated with it, via which the code may be entered. Instead, there may be a common keypad which is operable to designate a particular enclosure and associated lock and receive the code. The enclosure may be defined by a cuboid housing having a displaceable and lockable access opening, e.g. a hinged door.

The charging station may be solar powered. In such case, the charging station may include at least one solar panel integrated with, connected or connectable to a base unit. The base unit may include a rechargeable battery for storing power received from the solar panel for use on demand, e.g. to power the charging terminals and communication module.

The charging terminal may include a cable with a connector compatible with a charging socket of a mobile telephone. The connector may be a USB-type (e.g. USB micro), an Apple iPhone connector, or any other connector. The charging terminal may include a socket (e.g. a USB socket) for connection of a charging cable and connector. Thus, the cable may be modular so that it can be swapped and changed as desired. Each charging terminal may be unpowered by default. The control module may thus be operable to activate or power the charging terminal, in response to the subscriber having sufficient airtime.

The input arrangement may be in the form of a keypad, a touch screen, an IVR system or the like. The mobile subscriber identifier may be a mobile telephone number (MSISDN number) of the subscriber.

The control module may be operable to provide access to a lockable enclosure in response to receipt of a code not generated by the control module. For instance, the subscriber may purchaser charging time directly from his mobile telephone, or other device, and the code may be communicated to the mobile telephone and accepted by the charging station.

The communication module may be operable to communicate over a mobile telephone network. The communication module may thus be a GSM modem, 3G modem, or the like.

The charging station may include a processor and a computer readable medium. The control module may be a conceptual module corresponding to a functional task performed by the processor. To this end, the charging station may include a computer program or a set of instructions, stored on the computer-readable medium, to direct the operation of the processor. It is to be understood that the processor may be one or more microprocessors, controllers, or any other suitable computing device, resource, hardware, software, or embedded logic.

The charging station may include a local database operable to store charging details, e.g. mobile subscriber identifiers, charging times/dates and associated costs. The contents, or a portion thereof, of the local database may be communicated intermittently to a remote database.

By way of development, the charging station may be operable to permit the subscriber also to purchase or top-up airtime in his account.

According to another aspect of the invention, there is provided an authorisation server which includes:
a communication arrangement; and
a billing module operable to:
   receive from a charging station, via the communication arrangement, a query communication including a mobile subscriber identifier;
   query whether or not the subscriber has sufficient airtime in his account to pay for use of the charging station;
   deduct, in response to the subscriber having sufficient airtime, an amount of airtime from the account of the subscriber; and
   generate and send, via the communication arrangement, a response communication indicative of whether or not the subscriber is authorised to use the charging station.

The authorisation server may be separate from infrastructure of a mobile network provider of the subscriber. In such case, the billing module may be operable to communicate with a server of the mobile network provider thereby to query and deduct. Instead, the authorisation server may form part of the infrastructure of the mobile network provider. In such case, the billing module may be operable to query and deduct a subscriber account database directly.

The authorisation server may include a database operable to store thereon charging details, e.g. mobile subscriber identifiers, charging times/dates and associated costs.

The authorisation server may also be operable to receive query communications from sources other than the charging station, for example from a mobile telephone directly.

The invention extends to a charging system which includes:
a charging station as defined above; and
an authorisation server as defined above.

The invention extends further to a method of operating a charging station for charging mobile electronic devices, the method including:
receiving from a mobile subscriber an input including a mobile subscriber identifier;
generating and sending a query communication including the mobile subscriber identifier to a remote authorisation server, the query communication serving to query whether or not the subscriber has sufficient airtime in his account to pay for use of the charging station;
receiving a response communication indicative of whether or not the subscriber has sufficient airtime in his account to pay for use of the charging station; and
providing access to a lockable enclosure and activating its associated charging terminal, in response to the subscriber having sufficient airtime.

The invention extends still further to a method of authorising use of a charging station for charging mobile electronic devices, the method including:
receiving from the charging station a query communication including a mobile subscriber identifier;
querying whether or not the subscriber has sufficient airtime in his account to pay for use of the charging station;
deducting, in response to the subscriber having sufficient airtime, an amount of airtime from the account of the subscriber; and
generating and sending a response communication indicative of whether or not the subscriber has been authorised to use the charging station.

Accordingly to another aspect of the invention, there is provided a computer-readable medium having stored thereon a computer program which, when executed by a computer, causes the computer to perform a method as defined above.

### BRIEF DESCRIPTION OF DRAWINGS

The invention will now be further described, by way of example, with reference to the accompanying diagrammatic drawings.

In the drawings:

FIG. 1 shows a three-dimensional view of a charging station, in accordance with the invention;

FIG. 2 shows a schematic view of the charging station of FIG. 1;

FIG. 3 shows a schematic view of an authorisation server in accordance with the invention;

FIG. 4 shows a schematic view of a charging system in accordance with the invention;

FIG. 5 shows a flow diagram of methods in accordance with the invention; and

FIG. 6 shows a schematic view of a computer within which a set of instructions, for causing the computer to perform any one or more of the methodologies discussed herein, may be executed.

### DETAILED DESCRIPTION OF EXAMPLE EMBODIMENT

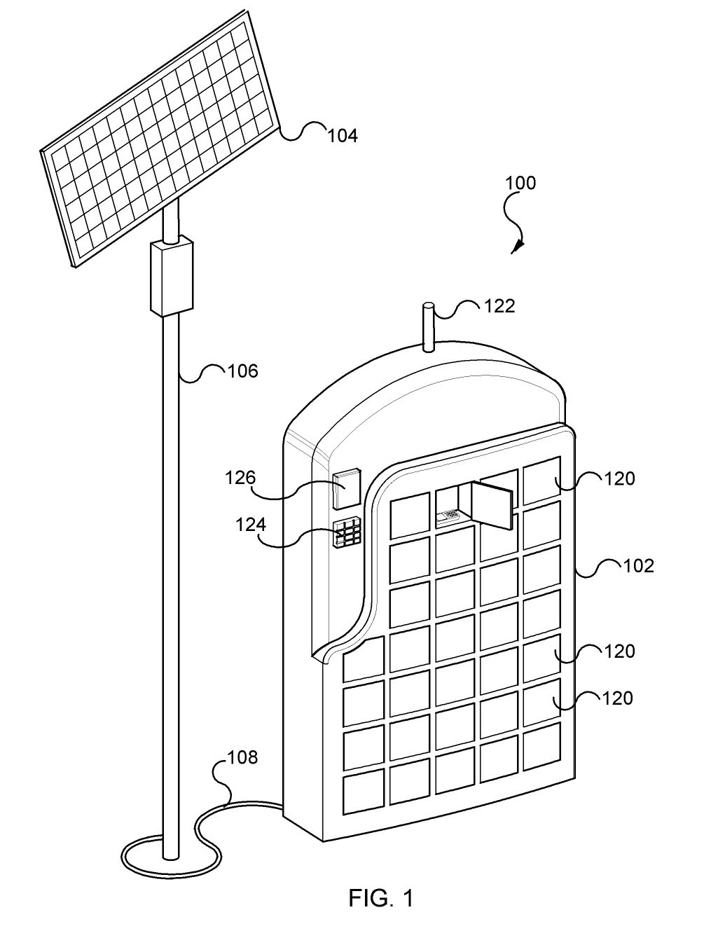

Referring initially to FIG. 1, reference numeral 100 generally indicates a charging station in accordance with the invention. The charging station includes a base unit 102 and a solar panel 104 supported by a post 106 and connected to the base unit 102 by an electrical cable 108.

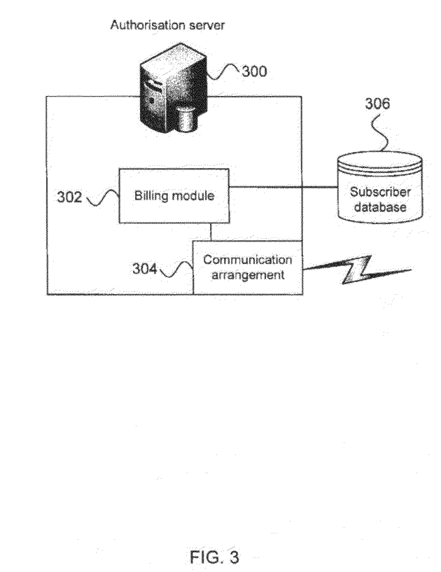

The charging station 100 (and specifically the base unit 102) has a plurality of lockable enclosures 120 and a communication module 122 operable to communicate with at least a remote authorisation server 300 (refer to FIG. 3). The communication module 122 in this example is a GSM modem operable to communicate via a mobile telephone network. The charging station 100 also includes an input arrangement in the form of a keypad 124 and an output arrangement in the form of a display screen 126.

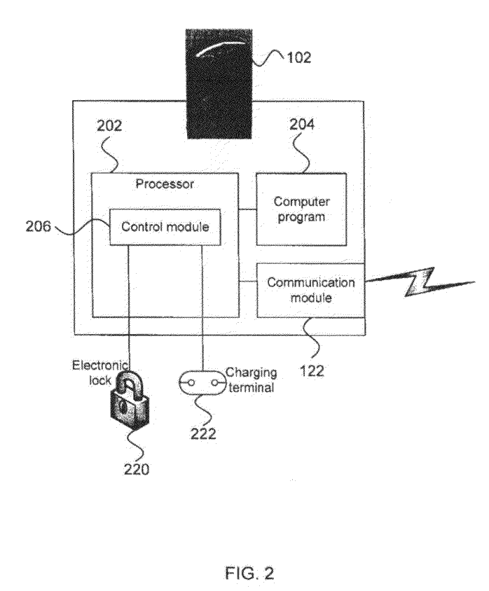

Referring now also to FIG. 2, the charging station 100 includes a processor 202 and a computer program 204 stored on a computer-readable medium (not illustrated). The computer program 204 is operable to direct the operation of the processor 202 enabling the processor 202 to embody a control module 206 for controlling the operation of the charging station 100.

An electronic lock 220 and a charging terminal 222 are associated with each of the enclosures 120. The control module 206 is communicatively coupled to the keypad 124, the screen 126, the lock 220 and the charging terminal 222 to direct their operation.

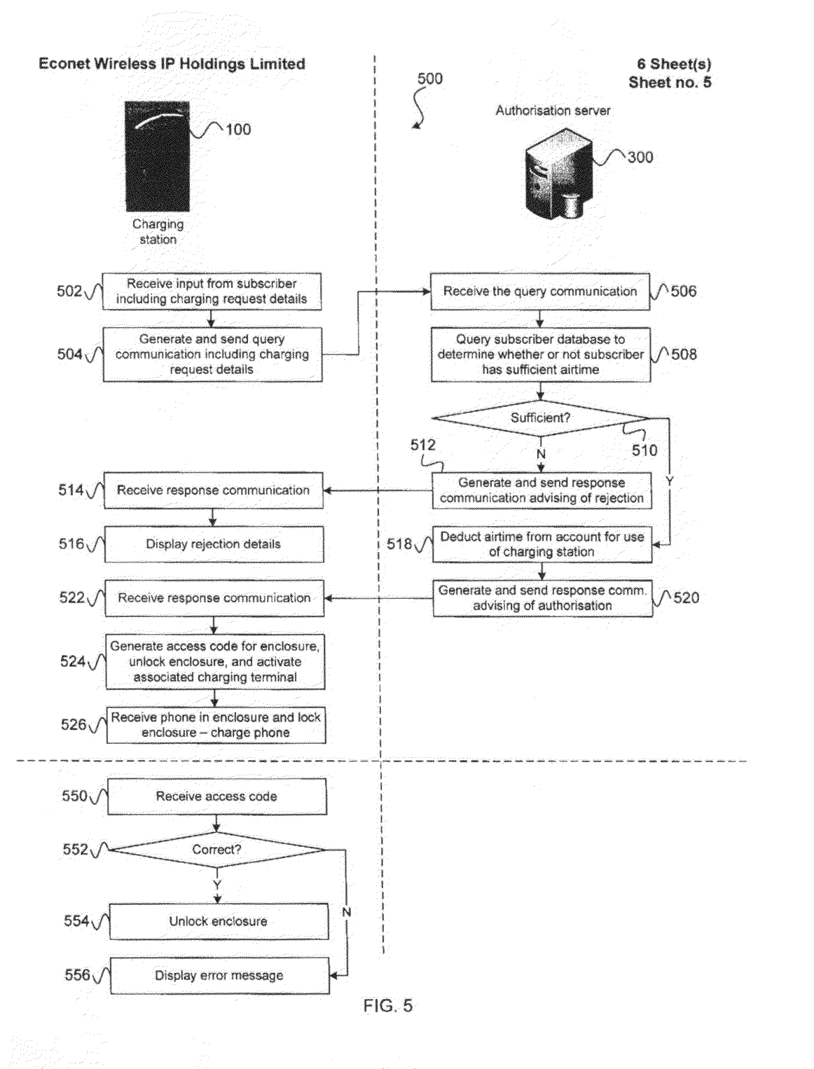

In broad terms, the keypad is operable to receive a mobile subscriber identifier in the form of a telephone number, and communicate with the authorisation server 300 to determine whether or not an account associated with that telephone number has sufficient airtime to pay for the charging services offered by the charging terminal 100. If so, a code is issued for opening the electronic lock 220 of an available enclosure 120 and the associated charging terminal 222 is powered. This method is described in more detail with reference to FIG. 5.

FIG. 3 illustrates the authorisation server 300 which includes a billing module 302, a communication arrangement 304 and a subscriber database 306. The billing module 302 is operable to interrogate the subscriber database 306 which contains a list of subscribers and their account information. The subscriber database 306 may be hosted by the authorisation server 300 or alternatively by a remote computer server networked to the authorisation server 300. The communication arrangement 304 is a network interface device (such as a USSD gateway) and is operable to receive and send messages from the charging station 100. Importantly, the billing module 302 is operable to authorise use of the charging station 100 and deduct a fee in the form of a portion of airtime (e.g. US$1 for 2 hours of charging) from a mobile account of a subscriber.

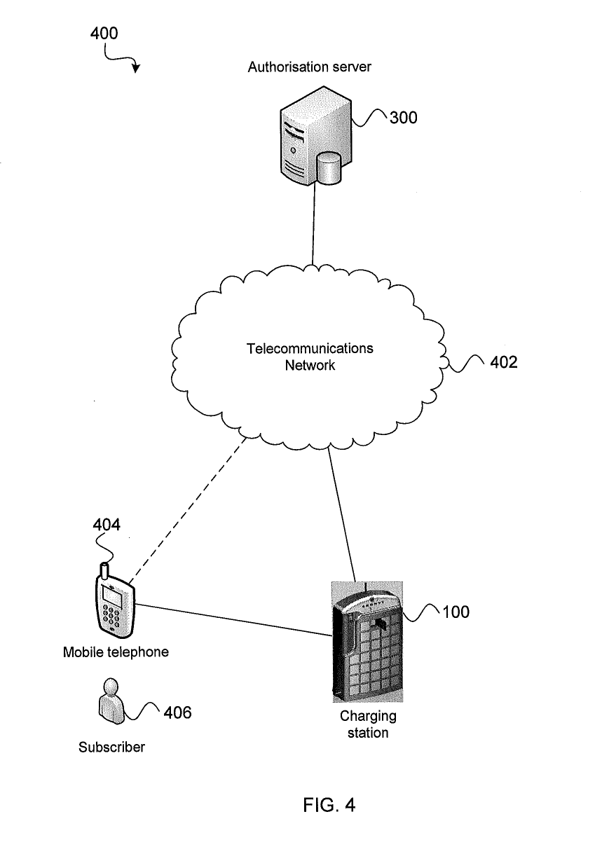

FIG. 4 shows a charging system 400 including the charging station 100 and the authorisation server 300 which are communicatively coupled by means of a telecommunications network 402 which includes a mobile telephone network. A subscriber 406 owns a mobile phone 404 (although the specifications of the mobile phone 404 are largely irrelevant) which is capable of charging by the charging station 100.

The invention will be further described with reference to a practical example and to FIG. 5 which shows methods 500. It will be appreciated that the methods 500 are combined methods illustrated from the perspectives of both the charging station 100 and the authorisation server 300. The methods 500 may be performed by the same party, or by separate or unrelated parties, at distributed nodes.

The subscriber 406 realises that his mobile phone 404 is nearly flat. He would therefore like to recharge it. He notes a nearby charging station 100 in public premises and approaches the charging station 100 to avail himself of its services.

The screen 126 displays a welcome message and prompts the subscriber 406 to press any key on the keypad 124 to continue. The subscriber presses a key and rates (e.g. US$0.50 for 30 mins or US$1 for 2 hours) are displayed, along with instructions to input the telephone number (MSISDN number) of the subscriber's account, so that the fee can be deducted from his airtime.

Accordingly, the subscriber 406 enters charging request details including his telephone number (i.e. a mobile subscriber identifier) and a selected charging option which is received (at block 502) by the charging station 100. The control module 206 of the charging station 100 generates and sends (at block 504) via the communication module 122 a query communication including the charging details. The query communication is sent across the mobile telephone network 402 and received (at block 506) by the communication arrangement 304 of the authorisation server 300.

The billing module 302 of the authorisation server 300 queries (at block 508) the subscriber database 306 to determine (at block 510) whether or not the subscriber 406 has sufficient airtime for use of the charging station 100. If not, the billing module 302 rejects the request and generates and sends (at block 512) a response communication advising of the rejection. The charging station 100 accordingly receives (at block 514) the response communication and displays (at block 516) details of the rejection on the display screen 126, e.g. “Your request is declined due to insufficient airtime.”

However, if the account of the subscriber 406 has sufficient airtime, the billing module 302 deducts (at block 518) an amount of airtime corresponding to the charging request (e.g. US$1) and generates and sends (at block 520) a response communication advising that the charging request has been authorised/approved.

The charging station 100 receives (at block 522) the response communication approving the charging request. In response to the approval, the control module 206 allocates an available enclosure 120 to the subscriber 406 for the charging session and activates (at block 524) the charging terminal 222 associated with the allocated enclosure 120. The control module also generates (at block 524) a four digit access code associated with the lock 220 of the allocated enclosure 120 and displays the code and the number of the allocated enclosure 120 on the screen 126 for the subscriber to note, e.g. “Your session code is 2468 and your charging enclosure is no. 10.”

The subscriber 406 plugs his mobile telephone 404 into the charging terminal 222 which immediately begins (at block 526) charging the phone 404. The subscriber 406 closes the door of the enclosure 120 and locks it by entering his code on the keypad 124. The charging terminal 222 will remain powered for the duration of the charging session. The enclosure 120 will remain locked until the correct code is entered to open it.

Thus, to retrieve his phone, the subscriber 406 returns to the charging station 100 some time later. His phone 404 will still be securely locked in its enclosure 120. The subscriber 406 enters (at block 550) the number of the enclosure (e.g. 10) in which his phone 404 is charging and the associated code (e.g. 2468). The control module 206 determines (at block 552) whether or not the code is correct and, if so, unlocks (at block 554) the enclosure 120 but, if not, displays (at block 556) an error message (e.g. “Wrong code.”) and leaves the enclosure 120 locked.

In an alternative deployment, the billing module 302 of the authorisation server 300 may be operable to generate the code and merely communicate it to the charging station 100.

In another alternative deployment, the initial query communication can be sent directly from the mobile phone 404. In such case, the subscriber 406 composes and sends the query communication (e.g. a USSD message) to a predefined telephone number (e.g. a shortcode) associated with the authorisation server 300. In such case the authorisation server 300 will receive and process the query communication in a similar fashion as one received from the charging station 100. However, the response communication will be sent back to the mobile phone 404. When the subscriber 406 enters the code into the charging station 100, a second round of communication between the charging station 100 and the authorisation server 300 may be necessitated to verify the code.

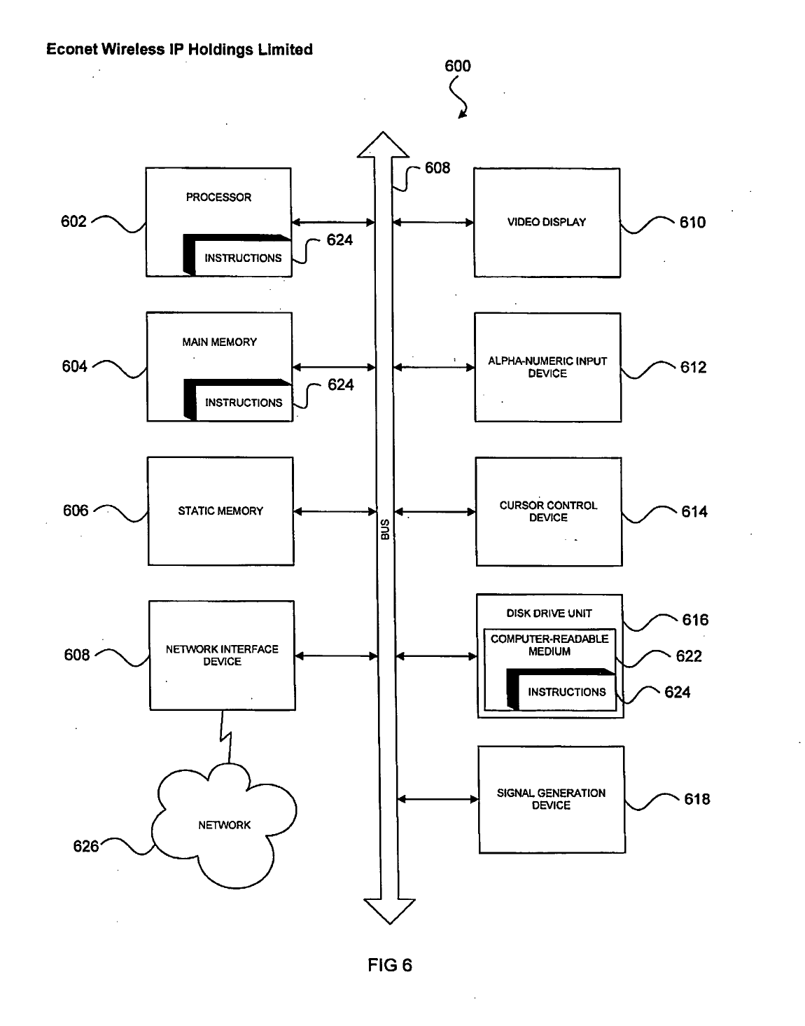

FIG. 6 shows a diagrammatic representation of a computer in the example form of a computer system 600 within which a set of instructions, for causing the computer to perform any one or more of the methodologies discussed herein, may be executed. In alternative embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment. The computer may be a personal computer (PC), a tablet PC, a set-top box (STB), a Personal Digital Assistant (PDA), a cellular telephone, a web appliance, a network router, switch or bridge, or any computer capable of executing a set of instructions (sequential or otherwise) that specify actions to be taken by that computer. Further, while only a single computer is illustrated, the term “computer” shall also be taken to include any collection of computer that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 608.

The disk drive unit 616 includes a computer-readable medium 622 on which is stored one or more sets of instructions and data structures (e.g., software 624) embodying or utilised by any one or more of the methodologies or functions described herein. The software 624 may also reside, completely or at least partially, within the main memory 604 and/or within the processor 602 during execution thereof by the computer system 600, the main memory 604 and the processor 602 also constituting computer-readable media.

The software 624 may further be transmitted or received over a network 626 via the network interface device 608 utilising any one of a number of well-known transfer protocols (e.g., HTTP).

While the computer-readable medium 622 is shown in an example embodiment to be a single medium, the term “computer-readable medium” should be taken to include a single medium or multiple media (e.g., a centralised or distributed database, and/or associated caches and servers) that store the one or more sets of instructions. The term “computer-readable medium” shall also be taken to include any medium that is capable of storing, encoding or carrying a set of instructions for execution by the computer and that cause the computer to perform any one or more of the methodologies of the present embodiments, or that is capable of storing, encoding or carrying data structures utilised by or associated with such a set of instructions. The term “computer-readable medium” shall accordingly be taken to include, but not be limited to, solid-state memories, optical and magnetic media, and carrier wave signals.

The charging station 100 and/or the authorisation server 300 may be in the form of the computer system 600, or may include some components thereof.

The Applicant believes that the invention as exemplified is advantageous as it allows for charging of mobile phones or other electronic devices in almost any area, including rural areas. All that is needed for the charging station 100 to function is mobile phone coverage. Connection to an electricity distribution network and a landline network is not required. The charging station 100 is thus environmentally friendly.

Also, the charging station 100 can be operated profitably which makes widespread deployment more attractive. Charging fees can be billed conveniently to an existing airtime account, and it is therefore convenient and relatively cost effective for the subscriber 406 too.

1. A charging station for charging mobile electronic devices, the charging station including:
a plurality of lockable enclosures, each having an associated charging terminal;
an input arrangement operable to receive a mobile subscriber identifier;
a communication module operable to communicate with a remote authorisation server; and
a control module operable to:
generate and send, via the communication module, a query communication including the mobile subscriber identifier to the remote authorisation server, the query communication serving to query whether or not the subscriber has sufficient airtime in his account to pay for use of the charging station;
receive, via the communication module, a response communication indicative of whether or not the subscriber has sufficient airtime in his account to pay for use of the charging station; and
provide access to a lockable enclosure and its associated charging terminal, in response to the subscriber having sufficient airtime.

2. The charging station as claimed in claim 1, in which each enclosure is electronically lockable and which includes a plurality of electronic locks respectively associated with the enclosures.

3. The charging station as claimed in claim 2, in which the control module provides access to a lockable enclosure by issuing a code to the subscriber.

4. The charging station as claimed in claim 3, in which each lock has a keypad associated with it, via which the code may be entered or in which there is a common keypad which is operable to designate a particular enclosure and associated lock and receive the code.

5. The charging station as claimed in claim 1, which is solar powered and which includes at least one solar panel integrated with, connected or connectable to a base unit.

6. The charging station as claimed in claim 5, in which the base unit includes a rechargeable battery for storing power received from the solar panel for use on demand.

7. The charging station as claimed in claim 1, which includes a cable with a connector compatible with a charging socket of a mobile telephone.

8. The charging station as claimed in claim 7, in which the cable is modular so that it can be swapped and changed as desired.

9. The charging station as claimed in claim 2, in which the control module is operable to provide access to a lockable enclosure in response to receipt of a code not generated by the control module.

10. The charging station as claimed in claim 1, which includes a local database operable to store charging details, e.g. mobile subscriber identifiers, charging times/dates and associated costs.

11. The charging station as claimed in claim 1, which is operable to permit the subscriber also to purchase or top-up airtime in his account.

12. An authorisation server which includes:
a communication arrangement; and
a billing module operable to:
receive from a charging station, via the communication arrangement, a query communication including a mobile subscriber identifier;
query whether or not the subscriber has sufficient airtime in his account to pay for use of the charging station;
deduct, in response to the subscriber having sufficient airtime, an amount of airtime from the account of the subscriber; and
generate and send, via the communication arrangement, a response communication indicative of whether or not the subscriber is authorised to use the charging station.

13. The authorisation server as claimed in claim 12, which includes a database operable to store thereon charging details.

14. The authorisation server as claimed in claim 12, which is also operable to receive query communications from sources other than the charging station.

15. A charging system which includes:
a charging station charging station for charging mobile electronic devices, the charging station including:
a plurality of lockable enclosures, each having an associated charging terminal;
an input arrangement operable to receive a mobile subscriber identifier;
a communication module operable to communicate with a remote authorisation server; and
a control module operable to:
generate and send, via the communication module, a query communication including the mobile subscriber identifier to the remote authorisation server, the query communication serving to query whether or not the subscriber has sufficient airtime in his account to pay for use of the charging station;
receive, via the communication module, a response communication indicative of whether or not the subscriber has sufficient airtime in his account to pay for use of the charging station; and
provide access to a lockable enclosure and its associated charging terminal, in response to the subscriber having sufficient airtime; and
an authorisation server which includes:
a communication arrangement; and
a billing module operable to:
receive from a charging station, via the communication arrangement, a query communication including a mobile subscriber identifier;
query whether or not the subscriber has sufficient airtime in his account to pay for use of the charging station;
deduct, in response to the subscriber having sufficient airtime, an amount of airtime from the account of the subscriber; and
generate and send, via the communication arrangement, a response communication indicative of whether or not the subscriber is authorised to use the charging station.

16. A method of operating a charging station for charging mobile electronic devices, the method including:
receiving from a mobile subscriber an input including a mobile subscriber identifier;
generating and sending, via a mobile communication network, a query communication including the mobile subscriber identifier to a remote authorisation server, the query communication serving to query whether or not the subscriber has sufficient airtime in his account to pay for use of the charging station;
receiving a response communication, via the mobile communication network, indicative of whether or not the subscriber has sufficient airtime in his account to pay for use of the charging station; and
providing access to a lockable enclosure and activating its associated charging terminal, in response to the subscriber having sufficient airtime.

17. A method of authorising use of a charging station for charging mobile electronic devices, the method including:
receiving, via a mobile communication network, from the charging station a query communication including a mobile subscriber identifier;
querying whether or not the subscriber has sufficient airtime in his account to pay for use of the charging station;
deducting, in response to the subscriber having sufficient airtime, an amount of airtime from the account of the subscriber; and
generating and sending a response communication, via the mobile communication network, indicative of whether or not the subscriber has been authorised to use the charging station.

18. A non-transitory computer-readable medium having stored thereon a computer program which, when executed by a computer, causes the computer to perform a method as claimed in claim 16.

19. A non-transitory computer-readable medium having stored thereon a computer program which, when executed by a computer, causes the computer to perform a method as claimed in claim 17.
